(19) United States
(12) Patent Application Publication
(10) Pub. No.: US 2013/0016066 A1
(43) Pub. Date: Jan. 17, 2013

(54) ELECTRONIC DEVICE AND TOUCH MODULE THEREOF

(71) Applicants: Chien-Wei Chen, New Taipei City (TW); Ching-Fu Hsu, New Taipei City (TW); Jun-Hong Wen, New Taipei City (TW); Yen-Chi Liu, New Taipei City (TW)

(72) Inventors: Chien-Wei Chen, New Taipei City (TW); Ching-Fu Hsu, New Taipei City (TW); Jun-Hong Wen, New Taipei City (TW); Yen-Chi Liu, New Taipei City (TW)

(21) Appl. No.: 13/341,774

(22) Filed: Dec. 30, 2011

(30) Foreign Application Priority Data
Jul. 15, 2011 (TW) 100125168

(51) Int. Cl. G06F 3/042

(52) U.S. Cl. 345/175

(57) ABSTRACT

An electronic device and its touch module are provided. The touch module includes a touch area, a detecting device, and a touch position determining device. The touch area is formed on a case of the electronic device, wherein the touch area includes a plurality of holes; each of the holes can allow light to pass through it when it is not covered by an external object, but cannot allow light to pass through it when it is covered by an external object. The detecting device is positioned under the touch area for detecting whether each hole can allow light to pass through it to determine whether each hole is covered by an external object. The touch position determining device is connected to the detecting device for determining the touch position of the external object according to whether each hole is covered or not.

### BACKGROUND OF THE INVENTION

1. Field of the Invention

The present invention relates to an electronic device and its touch module; more particularly, the present invention relates to an electronic device and its touch module with its touch area having arrays of holes.

2. Description of the Related Art

Generally, touchpads are classified as capacitive, resistive, surface acoustic wave, infrared, and electromagnetic types. However, if the case of a notebook computer is made of metal to present a hard and durable appearance, and if the case cannot be cracked in order to maintain the integral appearance, then the options for touchpad types will be limited.

For example, the theory of capacitive touchpads is based on the capacitance change, which is caused by the combination of the static electricity on the electrodes of the touch pad and on the human finger. The capacitance change results in an induced electric current, which is used for measuring the coordinates of the finger-touchpad contact. Therefore, there cannot be any conductive material between the finger and the capacitive touchpad. Capacitive touchpads must be positioned under a plastic notebook case or above a plastic notebook case and covered by a decorative plastic sheet. Capacitive touchpads cannot be positioned under a metal notebook computer case without breaking the integrity of the case. The theory of resistive touchpads is based on the voltage change, which is caused by using pressure to make the upper and lower electrodes connect to each other, is used for measuring the coordinates of the finger-touchpad contact. However, since the rigidity of a metal case is fairly high, resistive touchpads are not suitable for positioning under a metal case. The theory of surface acoustic wave touchpads is based on making a uniform acoustic force field in the touch area, the uniform acoustic force field being formed by ultrasonic transmitters and receivers in three corners of the touch area. When the acoustic wave contacts a soft material, the energy of the wave will be reduced, such that the coordinates of the finger-touchpad contact can be measured. However, since the volume of surface acoustic wave touchpads is fairly large, this kind of touchpad is not suitable for notebook computers. The theory of electromagnetic touchpads is based on electromagnetic induction, which is caused by moving a signal transmitter (such as an electromagnetic pen) close to a signal receiver (such as an electromagnetic pad), such that the magnetic flux will change and the coordinate of the contact can be measured by calculating the magnetic flux change. However, this kind of touchpad cannot work with human fingers, for they can work only with special electromagnetic transmitters. Therefore, electromagnetic touchpads are not suitable for notebook computers. The theory of infrared touchpads is based on detecting the change of infrared signals, which is caused by setting up infrared transmitters and receivers around the touch area and then using an opaque object to block the infrared signal transmitted from the transmitters. In this way, the receivers can detect the change of infrared signal to measure the coordinates of the contact. However, the volume of infrared touchpads is fairly large, so infrared touchpads are not suitable for notebook computers.

FIG. 1 illustrates an infrared touchpad of the prior art. This infrared touchpad comprises a touch area 91, infrared transmitters 92 around the touch area 91, and infrared receivers 93. The infrared receivers 93 can detect the change of infrared signals from infrared transmitters 92 to measure the coordinates of the touch. However, the infrared transmitters 92 and infrared receivers 93 must be positioned above the touch area 91, such that the infrared rays can cover the whole touch area 91. Therefore, there will be a gap L between the infrared transmitters 92, infrared receivers 93, and the case of the electronic device 90, so the touch area 91 and case 90 cannot be integral.

Therefore, there is a need to provide a new touch module to keep the integral appearance for the touch area and case of an electronic device.

### SUMMARY OF THE INVENTION

It is an object of the present invention to provide a touch module that maintains an integral appearance with the case of the electronic device.

To achieve the abovementioned object, the present invention provides an electronic device and its touch module. The touch module includes a touch area, a detecting device, and a touch position determining device. The touch area is formed on a case of the electronic device, wherein the touch area includes a plurality of holes; light can pass through each of the holes when it is not covered by an external object, but cannot pass through when it is covered by the external object. The detecting device is positioned under the touch area for detecting whether each hole allows light to pass in order to determine whether each hole is covered by an external object. The touch position determining device is connected to the detecting device for determining the touch position of the external object according to whether each hole is covered by an external object or not.

In one embodiment of the present invention, the plurality of holes is formed by laser perforation on the case of the electronic device.

In one embodiment of the present invention, the plurality of holes is arranged as an array.

In one embodiment of the present invention, the detecting device is a light sensor to detect the change of light intensity for each hole, and to detect whether light passes through each hole. Or, the detecting device is an image sensor, such as a camera, to detect changes in image brightness or gray-scale for each hole, and to detect whether light passes through each hole.

In one embodiment of the present invention, the plurality of holes is filled with a transparent material, such as an UV curing adhesive or a polyurethane adhesive.

In one embodiment of the present invention, the touch module further comprises a light source device that is positioned under the touch area used for transmitting light.

In one embodiment of the present invention, the electronic device is a notebook with a metal case.

### BRIEF DESCRIPTION OF THE DRAWINGS

FIG. 1 illustrates a schematic view of an infrared touchpad according to a known prior art.

FIG. 2 illustrates a schematic view of the electronic device according to one embodiment of the present invention.

FIG. 3 illustrates a schematic view of the touch module according to one embodiment of the present invention.

FIG. 4 illustrates a schematic view of the detecting device that detects the external light source according to one embodiment of the present invention.

FIG. 5 illustrates a schematic view of the detecting device that detects the internal light source according to one embodiment of the present invention.

FIG. 6 illustrates a schematic view of the simulation detection result for the detecting device according to one embodiment of the present invention.

FIG. 7A illustrates a schematic view of the simulation result, which detects the change of voltage waveforms via an X-axis and a Y-axis, according to one embodiment of the present invention.

FIG. 7B illustrates a schematic view of the simulation result, which detects the change of voltage waveforms via an X-axis and a Y-axis, according to one embodiment of the present invention.

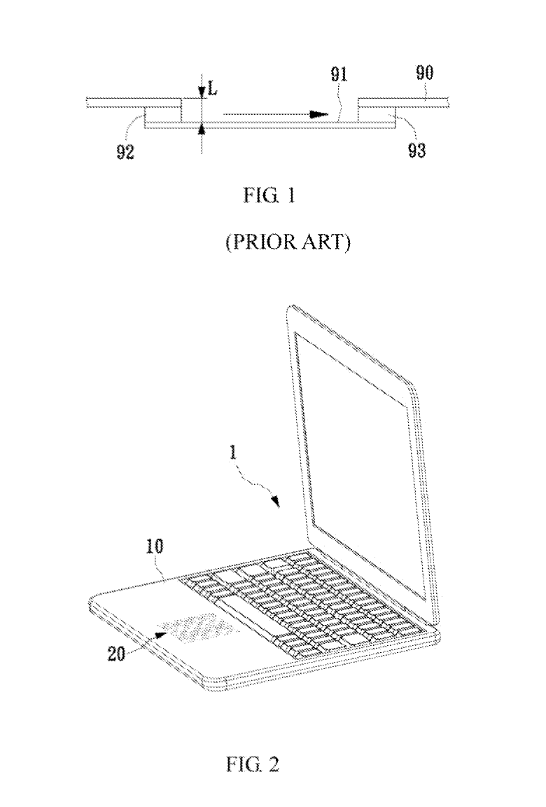

### DETAILED DESCRIPTION OF THE PREFERRED EMBODIMENT

The objects, advantages and innovative features of the invention will become more apparent from the following detailed descriptions when taken together with the accompanying drawings.

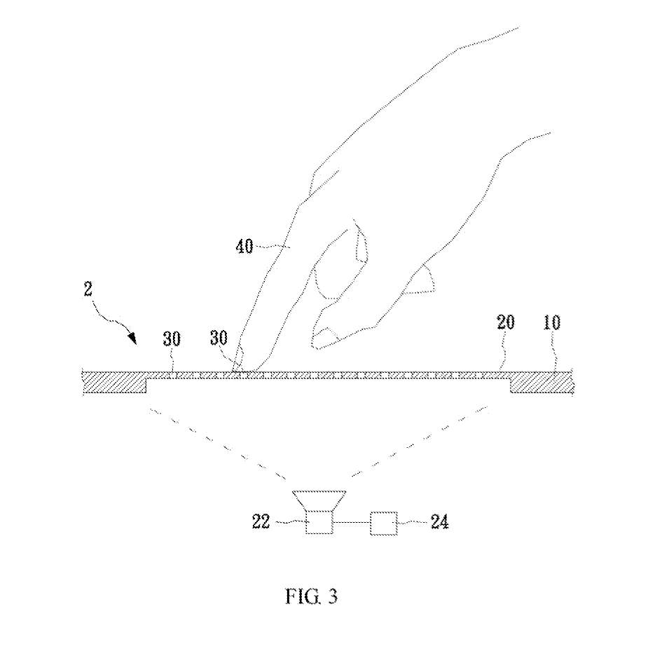

Please refer to FIG. 2 and FIG. 3, which illustrate schematic views of the electronic device and touch module according to one embodiment of the present invention, wherein FIG. 2 illustrates the schematic view of the electronic device, and wherein FIG. 3 illustrates the schematic view of the touch module.

As shown in FIG. 2 and FIG. 3, the present invention provides an electronic device 1 and its touch module 2, which is formed in the electronic device 1. As shown in FIG. 3, the touch module 2 comprises a touch area 20, a detecting device 22, and a touch position determining device 24. As shown in FIG. 2, the touch area 20, which is formed on a case 10 of the electronic device 1 has an integral appearance with the case 10, wherein the touch area 20 includes a plurality of holes 30; each of the holes 30 can allow light to pass through it when it is not covered by an external object 40, but light cannot pass through it when it is covered by an external object 40. In this embodiment, the external object 40 is the user's finger, but the present invention is not limited to that application; and the external object 40 can be a stylus or other similar devices. The detecting device 22 is positioned under the touch area 20 for detecting whether each hole 30 is admitting light to determine whether each hole 30 is covered by the external object 40. The touch position determining device 24 is connected to the detecting device 22 for determining the touch position of the external object 40 according to whether each hole 30 is covered by the external object 40 or not.

In one embodiment of the present invention, the plurality of holes 30 formed by laser perforation of the case 10 of the electronic device 1 is microscopic, such that the plurality of holes 30 cannot be observed by the naked human eye. However, this invention is not limited to that design; the plurality of holes 30 can be formed by a normal perforation method and observable by the naked human eye.

Furthermore, in one embodiment of the present invention, the plurality of holes 30 are arranged as an array, but the present invention is not limited to the design.

In one embodiment of the present invention, the electronic device 1 is a notebook, and the case 10 is made of an opaque metal, but the present invention is not limited to this design.

The present invention forms the touch area 20 on the case 10 (such as a metal case) of the electronic device 1 (such as a notebook) to detect the touching coordinates; therefore, the touch area 20 and the case 10 of the electronic device 1 can be integral. Besides, because of the array of the plurality of holes 30, this invention can detect touching coordinates, such that the detecting device 22 and the touch position determining device 24 can be positioned under the case 10 without being disturbed by the case 10. Furthermore, depending on design needs, the size of the touch area 20 can be reduced to that of a small touch module 2.

Furthermore, to prevent dust and dirt from blocking the plurality of holes 30, in one embodiment of the present invention, the plurality of holes 30 is filled with a transparent material, such as an UV curing adhesive or a polyurethane adhesive, but this invention is not limited to that design.

In one embodiment of the present invention, the detecting device 22 is a light sensor for detecting the change of light intensity for each of the holes 30, and to detect whether light passes through each of the holes 30. Or, the detecting device 22 is an image sensor, such as a camera, to detect changes in the image brightness or gray-scale for each of the holes 30, and to detect whether the light passes through each of the holes 30. In one embodiment of the present invention, the touch position determining device 24 is a device with the function of calculating the touching position and direction; this device may comprise software, hardware, or a combination of the above.

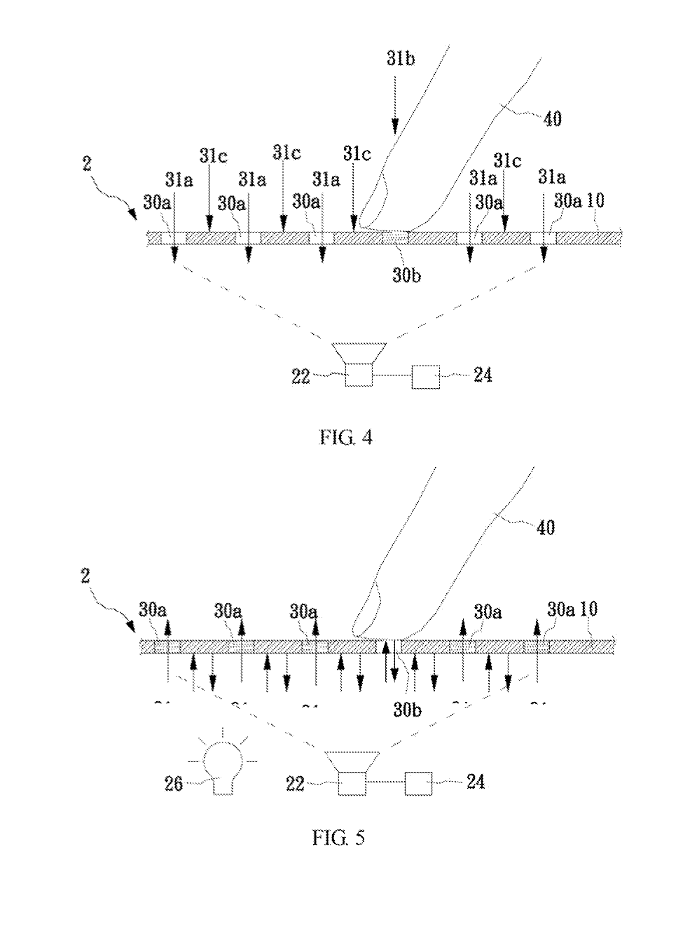

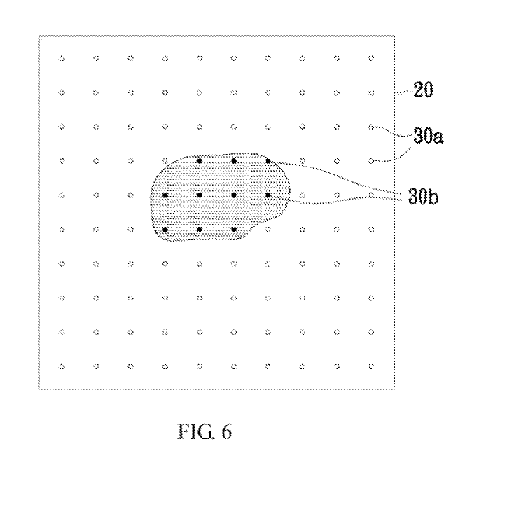

In one embodiment of the present invention, the light detected by the detecting device 22 may pass from an external light source outside the case 10 or from an internal light source inside the case 10 of the electronic device 1. Please refer to FIG. 4-6, which illustrate schematic views of the detecting device 22, which detects the external and internal light sources. FIG. 4 illustrates a schematic view of the detecting device 22 that detects the external light source; FIG. 5 illustrates a schematic view of the detecting device 22 that detects the internal light source; and FIG. 6 illustrates a schematic view of the simulation detection result for the detecting device 22.

As shown in FIG. 4, when the external light source (such as sunshine and office lighting) is bright enough, the present invention can use the external light for detection. As shown in FIG. 4, when a user touches the touch module 2 to operate it, each of the holes 30a is not covered by the external object 40 (such as the user's finger), so the light 31a can pass through each of the holes 30a; conversely, each of the holes 30b is covered by the external object 40, so the light 31b cannot pass through the holes 30b; and since the case 10 is made of an opaque metal, the light 31c cannot pass through the case 10, either. The detecting device 22 detects the change in light intensity or the change in image brightness of the plurality of holes 30a and 30b, to determine that the light 31a passes through the holes 30a and the light 31b does not pass through the holes 30b.

As shown in FIG. 5, in one embodiment of the present invention, the touch module 2 further comprises a light source device 26, which is positioned under the touch area 20. The light source device 26 is used for transmitting light, which is not limited to the visible light spectrum and could be infrared rays or invisible light of another wave range. As shown in FIG. 5, when the user touches the touch module 2 to operate it, each of the holes 30a is not covered by the external object 40, so the light 31a can pass through each of the holes 30a; conversely, each of the holes 30b is covered by the external object 40, so the light 31b cannot pass through the holes 30b and is reflected back to the detecting device 22; and since the case 10 is made of an opaque metal, the light 31c cannot pass through the case 10 and is reflected back to the detecting device 22. The detecting device 22 can detect the change in light intensity or the change in image brightness for the plurality of holes 30a and 30b, to determine that the light 31a passes through the holes 30a and the light 31b does not pass through the holes 30b but is reflected back to the detecting device 22, to determine that the external object 40 has covered holes 30b.

FIG. 6 illustrates the simulation detection result for the detecting device 22, wherein in FIG. 6, the holes 30a in the touch area 20 are not covered by the external object 40, but the holes 30b are covered. Then the touch position determining device 24 can calculate the relative coordinates of holes 30a and holes 30b via an algorithm, to determine the touching position of the external object 40. Meanwhile, if the external object 40 performs dynamic actions, such as dragging, both the detecting device 22 and the touch position determining device 24 can work continuously to determine the touching position and movement direction of the external object 40.

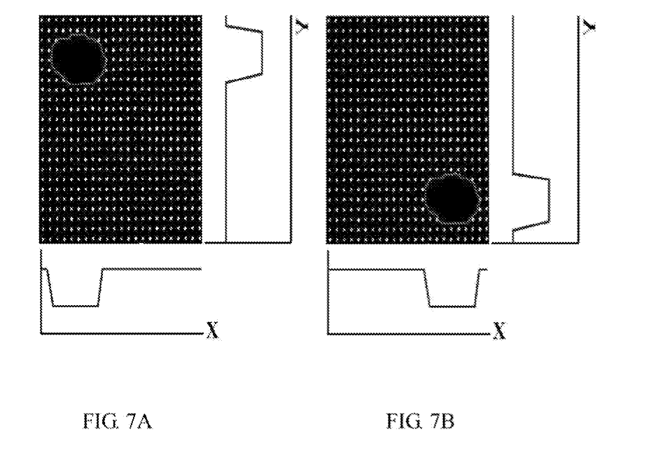

As shown in FIGS. 7A and 7B, in one embodiment of the present invention, the detecting device 22 detects changes in the light intensity or changes in the image brightness to generate the voltage signal of the X-axis and the Y-axis; then the touch position determining device 24 uses the change in voltage signal to calculate the touching position and movement direction of the external object 40. However, the present invention is not limited to this the design; for example, in one embodiment of the present invention, the detecting device 22 is a camera; when light passes through or reflects from the touch area 20 with the plurality of holes 30, the camera will detect the gray-scale. According to the change in gray-scale, the touch position determining device 24 can calculate the touching position and movement direction of the external object 40.

Furthermore, as shown in FIG. 5, in one embodiment of the present invention, the touch module 2 comprises a light source device 26, which can be turned off when the external light source is bright enough.

It must be noted that the above-mentioned embodiments are only for purposes of illustration. It is intended that the present invention covers modifications and variations of this invention provided that they fall within the scope of the following claims and their equivalents. Therefore, it will be apparent to those skilled in the art that various modifications and variations can be made to the structure of the present invention without departing from the scope or spirit of the invention.

What is claimed is:

1. A touch module, which is located in an electronic device, the touch module comprising:
a touch area formed on a case of the electronic device, wherein the touch area comprises a plurality of holes; each of the plurality of holes can allow light to pass through it when not covered by an external object, but cannot allow light to pass through it when covered by the external object;
a detecting device positioned under the touch area for detecting whether each hole can allow light to pass through it to determine whether each hole is covered by the external object; and
a touch position determining device connected to the detecting device for determining a touch position of the external object according to whether each hole is covered by the external object or not.

2. The touch module as claimed in claim 1, wherein the plurality of holes is arranged as an array to form an array of holes.

3. The touch module as claimed in claim 1, wherein the determining device is a light sensor for detecting a change in light intensity of each hole to determine whether each hole can allow light to pass through it.

4. The touch module as claimed in claim 1, wherein the determining device is an image sensor for detecting a change in image brightness of each hole to determine whether each hole can allow light to pass through it.

5. The touch module as claimed in claim 1, wherein each of the plurality of holes is filled with a transparent material.

6. The touch module as claimed in claim 5, wherein the transparent material is an ultraviolet curing adhesive or a polyurethane adhesive.

7. The touch module as claimed in claim 1, further comprising a light source device which is located under the touch area and is used for transmitting light.

8. An electronic device comprising:
a case; and
a touch module which comprises:
a touch area formed on the case, wherein the touch area comprises a plurality of holes; each of the plurality of holes can allow light to pass through it when not covered by an external object, but cannot allow light to pass through it when covered by the external object;
a detecting device positioned under the touch area for detecting whether each hole can allow light to pass through it to determine whether each hole is covered by the external object; and
a touch position determining device connected to the detecting device for determining a touch position of the external object according to whether each hole is covered by the external object or not.

9. The electronic device as claimed in claim 8, wherein the touch module comprises a light source device, which is located under the touch area and is used for transmitting light.

10. The electronic device as claimed in claim 9, wherein the determining device is a light sensor for detecting a change in light intensity of each hole to determine whether each hole can allow light to pass through it.

11. The electronic device as claimed in claim 9, wherein the determining device is an image sensor for detecting a change in image brightness of each hole to determine whether each hole can allow light to pass through it.
